(19) United States
(12) Patent Application Publication
(10) Pub. No.: US 2023/0141652 A1
(43) Pub. Date: May 11, 2023

(54) DEPLOYMENT DEVICE FOR NANO-SATELLITE

(71) Applicants: Centre National d'Études Spatiales, Paris (FR); MECANO I.D., TOULOUSE (FR)

(72) Inventors: Olivier DESLANDES, PARIS (FR); Jacques SICRE, TOULOUSE (FR); Lionel BONNES, TOULOUSE (FR)

(73) Assignees: Centre National d'Études Spatiales, PARIS (FR); MECANO I.D., TOULOUSE (FR)

(21) Appl. No.: 17/986,149

(22) Filed: Nov. 14, 2022

Related U.S. Application Data
(63) Continuation of application No. PCT/FR2021/050818, filed on May 11, 2021.

(30) Foreign Application Priority Data
May 11, 2020 (FR) 20/04623

(51) Int. Cl. B64G 1/64

(52) U.S. Cl. CPC B64G 1/641; B64G 1/645

(57) ABSTRACT

The present disclosure concerns a device for deploying a nanosatellite including a main structure mounted on a launching vehicle, a support frame carrying the nanosatellite, and a locking/unlocking structure. The locking/unlocking structure includes a first clamping element complementary to a second clamping element of the support frame, and an elastically deformable actuating element to allow, in a locking position, constrain the first clamping element to the second clamping element to retain the support frame to the main structure, and in an unlocking position, release the first clamping element from the second clamping element to release the support frame from the main structure causing it to be ejected.

### CROSS-REFERENCE TO RELATED APPLICATIONS

This application is a continuation of International Application No. PCT/FR2021/050818, filed on May 11, 2021, which claims priority to and the benefit of FR 20/04623 filed on May 11, 2020. The disclosures of the above applications are incorporated herein by reference.

### FIELD

The present disclosure relates to the field of deployment devices for nanosatellites.

### BACKGROUND

The statements in this section merely provide background information related to the present disclosure and may not constitute prior art.

Such nanosatellites are for example intended for scientific, observation or telecommunications missions.

From these deployment devices, there are known closed deployment devices formed by a container of elongated rectangular shape containing a nanosatellite to be deployed having a shape complementary to the container in accordance with the Cubesat standards. During deployment, the nanosatellite is guided by a system of rails disposed at each longitudinal edge of the container to guide the ejection of the nanosatellite increasing the mass of the deployment devices and the nanosatellite. Such deployment devices have the drawback of constraining the appendages of the nanosatellite, such as the solar panels or the telecommunication antennas for example.

In addition, the guide structure of these deployment devices imposes strong tolerance constraints in order to limit the risk of angular deviation or spin during their deployment.

Deployment devices called MLB for “Motorized LightBand” and SLB for “Standard Light Band” are also known, which are in the form of an upper annular band secured to the nanosatellite and a lower annular band secured to the launching vehicle, these two bands being released by a separation mechanism, such as an electric motor in the case of MLB devices, or such as a pyrotechnic firework in the case of SLB devices.

While these deployment devices are less bulky, lighter and make it possible to free the faces of the nanosatellite to release the constraints on the appendages, the absence of guiding means greatly increases the risk of angular deviation or spin of the nanosatellite during its deployment.

Another drawback of such a deployment device comes from the fact that it generates a rotation moment to the nanosatellite. Indeed, during the ejection of the nanosatellite to reach its orbit, the moment generates a rotation of the nanosatellite around its main axis. This induced rotation has the effect of constraining the stabilization of the nanosatellite after its ejection. For this, nanosatellite equipment such as motors are used to restore the stability of the nanosatellite.

This results in a loss of energy self-reliance of the nanosatellite. As a result, the mission lifetime of the nanosatellite is reduced.

Furthermore, in the case of SLB-type deployment devices, the presence of an explosives technician is necessary to prepare their arming or rearming.

### SUMMARY

This section provides a general summary of the disclosure and is not a comprehensive disclosure of its full scope or all of its features.

In one form, the present disclosure may overcome at least one of the cited drawbacks by suggesting to simplify the structure of deployment devices for nanosatellites while limiting the risk of angular deviation or spin of a nanosatellite when the latter is deployed.

For this, the present disclosure aims at providing a device for deploying a nanosatellite comprising:

a main structure provided to be mounted on a launching vehicle of the nanosatellite,

a support frame provided to carry the nanosatellite and to be ejected from the main structure with the nanosatellite,

a structure for locking/unlocking the support frame with respect to the main structure,

the locking/unlocking structure being movably mounted on the main structure,

the deployment device being characterized in that the locking/unlocking structure comprises:

a first clamping element complementary to a second clamping element of the support frame, and

an elastically deformable actuating element to allow:

in a locking position, constraining the first clamping element to the second clamping element in order to retain the support frame to the main structure, and

in an unlocking position, releasing the first clamping element from the second clamping element in order to release the support frame from the main structure causing it to be ejected.

The nanosatellite deployment device according to the present disclosure allows constraining the support frame via that of the locking/unlocking structure, and this by using simplified mechanical components.

In the unlocking position, the release of the support frame from the main structure allows the detachment and the ejection of the nanosatellite from the main structure.

The design of the deployment device that is simplified in this manner allows its standalone use without requiring the presence of a specialist to carry out the locking, that is to say the arming, or the rearming of the deployment device during the phases of tests for example.

Indeed, the arming or rearming of the deployment device is achieved by elastically deforming the actuating element to bring it from its unlocking position to its locking position.

The first clamping element and the second clamping element make it possible to constrain the support frame to the main structure so as to limit any play between them which may generate micro-shocks and make the dynamic behavior non-linear, therefore non-predictive, i.e. difficult to simulate.

The simplified architecture of the deployment device also makes it possible to have a robust device.

Furthermore, the deployment device according to the present disclosure improves the behavior and mechanical predictions of the nanosatellite during its ejection. Indeed, the locking/unlocking structure makes it possible to predetermine, on the one hand, the application of a pre-load and, on the other hand, to anticipate the behavior of the support frame released by the actuating element as well as the first clamping element and the second clamping element.

According to one form of the present disclosure, the first clamping element and the second clamping element provide radial and/or axial clamping of the locking/unlocking structure with respect to the support frame.

According to one form of the present disclosure, the first clamping element and the second clamping element have a toothed profile preferably asymmetrical. Such a thread is also called sawtooth-shaped thread.

Preferably, this thread is made without a helix angle.

An advantage of such a thread is to be able to limit the unlocking stroke while having enough expansion stroke to absorb the elastic energy of the main structure.

According to one form of the present disclosure, the first clamping element and the second clamping element are respectively formed by a circular clamping ring complementary to each other.

According to one variant, the circular clamping ring forming the first clamping element comprises a plurality of clamping jaws.

According to one form of the present disclosure, the actuating element is formed by a plurality of elastically deformable blades.

According to another embodiment of the present disclosure, the locking/unlocking structure comprises an element for retaining the locking/unlocking structure to the main structure.

According to one variant, the retaining element is formed by a retaining ring complementary to the first clamping element.

Advantageously, the retaining element is axially movable relative to the main structure and the first clamping element is radially movable relative to the retaining element.

The axial movement of the retaining element relative to the main structure and the radial movement of the first clamping element relative to the retaining element make it possible to release the axial or radial constraints that may be generated during the release of the support frame.

According to one form of the present disclosure, the elastically deformable actuating element comprises a peripheral shaft guided by a central shaft of the main structure, the peripheral shaft receiving an unlocking elastic compression element ensuring the switching from the locking position to the unlocking position.

Advantageously, in the locking position, a first position of the peripheral shaft makes it possible to compress the unlocking elastic compression element and forces an active position of the actuating element in which the first clamping element engages with the second clamping element and in the unlocking position, a second position of the peripheral shaft makes it possible to release the unlocking elastic compression element and restores a passive position of the actuating element in which the first clamping element disengages from the second clamping element.

Advantageously, in the locking position, a first position of the peripheral shaft makes it possible to compress the unlocking elastic compression element and forces an active position of the actuating element in which the first clamping element engages with the retaining element and in the unlocking position, a second position of the peripheral shaft makes it possible to release the unlocking elastic compression element and restores a passive position of the actuating element in which the first clamping element disengages from the retaining element.

It should be understood that the passive position of the actuating element corresponds to a mechanical rest position of the actuating element. In other words, the passive position of the actuating element corresponds to an unconstrained position of the actuating element.

It should be understood that the active position of the actuating element corresponds to an active mechanical position of the actuating element. In other words, the active position of the actuating element corresponds to a constrained position of the actuating element.

According to tone form of the present disclosure, the deployment device comprises a thrust plate including a guide tail intended to be received in a central shaft of the main structure, the support frame of the nanosatellite being in plane abutment on the thrust plate so as to allow ejection of the support frame and separation of the support frame from the thrust plate after ejection.

Such a thrust plate has the advantage of allowing guiding of the support frame carrying the nanosatellite during its ejection while allowing separation of the thrust plate from the support frame. Thus, the nanosatellite and the support frame may be ejected from the device without that the guide tail being attached thereto. Thus, the nanosatellite does not have the non-desired appendage represented by a guide tail emerging from the nanosatellite.

Furthermore, the guide tail slidably mounted relative to the central shaft makes it possible to limit the speed of angular deviation or spin during their deployment. This limits the risk of the rotation of the nanosatellite while being ejected.

According to an advantage of the present disclosure, the guide tail and the central shaft of the main structure are tightened according to an H7e6-type adjustment.

This small play makes it possible to guide the nanosatellite during ejection by taking up the rotation moment which limits the performance of the deployment device.

According to tone form of the present disclosure, a peripheral abutment of the thrust plate allows an axial holding of the support frame relative to the thrust plate.

Such a peripheral abutment advantageously makes it possible to provide a stable thrust of the support frame during its ejection. It also makes it possible to limit the rotation moment phenomenon.

The thrust plate makes it possible to reduce the angular deviation or spin to 2°/s, when the known deployment devices generate an angular deviation or spin comprised between 7 and 10°/s.

According to one form of the present disclosure, the support frame is hollowed out to receive the thrust plate.

According to one form of the present disclosure, the support frame bears on the main structure.

Advantageously, the support frame and the main structure match in shape at the level of the support.

According to one form of the present disclosure, the deployment device comprises a force take-up structure to hold the free end of the central shaft, the force take-up structure being formed of a central part surrounding the free end of the central shaft and a peripheral part extending from the central part to bear laterally on the main structure.

Advantageously, the force take-up structure allows the compression of the unlocking elastic compression element.

According to one form of the present disclosure, the locking/unlocking structure comprises a plurality of thrust elements providing pre-loading of the thrust plate.

Advantageously, the thrust elements are evenly distributed around the central shaft.

According to one form of the present disclosure, a thrust element comprises a guide body receiving a thrust rod retaining a thrust spring surrounding the guide body and retained between the guide body and the thrust rod, the thrust spring being provided to bear against the thrust plate.

According to one embodiment, the thrust rod is secured to the thrust plate. The rod secured to the thrust plate allows retaining the thrust plate during the ejection of the nanosatellite.

Such a thrust element makes it possible to control the position of the support of the rod on the thrust plate without transferring the moment generated by the thrust spring taken up by the guide body to the thrust plate.

Furthermore, the rod has an effect of limiting the radial force transmitted to the thrust plate.

According to one form of the present disclosure, the plurality of thrust elements is fixedly mounted on the main structure.

Thus, the main structure equipped with the plurality of thrust elements forms a subassembly that may be mounted on a traction machine in order to characterize the direction of thrust resulting from their combination.

Advantageously, the thrust element may comprise a setting wedge provided on the guide body to set the compression of the spring.

The setting wedge thus allows setting of each thrust element independently so that the thrust of the support frame is as stable as possible.

It should be noted that the deployment device may be adapted to a large number of nanosatellites. Indeed, each nanosatellite has a center of gravity which may be offset from the center of thrust of the thrust plate. The plurality of thrust elements that may be set by a setting wedge makes it possible to compensate for this offset between the center of gravity and the center of thrust thanks to the compression of the spring independently of the thrust elements.

According to one form of the present disclosure, the deployment device comprises a retention mechanism capable of blocking the actuating element in its locking position and unblocking the actuating element to bring it into its unlocking position.

When the actuating element comprises the peripheral shaft, the retention mechanism makes it possible to block the peripheral shaft in its first position and to unblock the peripheral shaft in its second position.

The retention mechanism advantageously comprises a blocking/unblocking element that may engage to block the actuating element in its locking position and disengage to unblock the actuating element and bring it to its unlocking position.

The blocking/unblocking element may advantageously be formed by a control member consisting of an actuator, actuated for example by a pyrotechnic charge, an electromagnetic force or any other technology making it possible to fulfill the unlocking function.

According to one variant, the peripheral shaft comprises a radial projection and the retention mechanism comprises a cam comprising a circular ramp cooperating with the radial projection to bring the peripheral shaft from its first position to its second position and vice versa.

Advantageously, the cam is rotatably movable around the peripheral shaft to allow movement of the radial projection along the circular ramp.

Advantageously, the circular ramp comprises an increasing linear portion bringing the radial projection between a low position corresponding to the unlocking position and a high position corresponding to the locking position.

Advantageously, the increasing linear portion is interrupted to allow passage of the radial projection directly from the high position to the low position.

Even more advantageously, the circular ramp successively comprises the increasing linear portion between a first position and a second position to allow linear guiding of the radial projection from the low position to the high position, then a flat linear portion between the second position and a third position to allow holding the radial projection in the high position, then the circular ramp is interrupted between the third position and the first position to allow the passage of the radial projection directly from the high position to the low position.

Such a circular ramp makes it possible to suddenly release the support frame. This greatly limits any phenomenon of mechanical propagation that could unbalance the support frame of the nanosatellite during ejection thereof.

According to one variant, the retention mechanism comprises an elastic element to bring the cam from a retaining position where the peripheral shaft is in its first position to a rest position where the peripheral shaft is in its second position.

Advantageously, the elastic element is a spiral spring.

According to one variant, the retention mechanism comprises a hooking element that may be disposed between the blocking/unblocking element and the cam to hold the cam in its retaining position.

The hooking element is advantageously provided to at least partially surround the circular ramp and to be compressed against the latter by the blocking/unblocking element.

When the blocking/unblocking element disengages axially to unblock the actuating element and bring it into its unlocking position, the hooking element is elastically biased to disengage from the circular ramp, thus releasing the cam for return it to its resting position.

According to a feature of the present disclosure, the deployment device is devoid of an electric motor.

Indeed, the unlocking and the ejection are provided by mechanical components.

The unlocking elastic compression element may be chosen from: an elastic spring, a composite blade, or even a spring with constant stiffness.

The unlocking elastic compression element is preferably of constant stiffness.

Preferably, at least one elastic unlocking compression element is an elastic spring.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a detailed view of a deployment device according to the present disclosure in the assembled state.

FIG. 2 illustrates a sectional view of a support frame represented in FIG. 1 on which a nanosatellite is disposed.

FIG. 3 illustrates an exploded view of the deployment device represented in FIG. 1.

FIG. 4A illustrates a half-sectional view of the deployment device represented in FIG. 1 in a locking position.

FIG. 4B illustrates a half-sectional view of the deployment device represented in FIG. 1 in an unlocking position.

FIG. 5A illustrates a half-sectional view of the deployment device represented in FIG. 1 in a first ejection phase of the nanosatellite after the unlocking of the device.

FIG. 5B illustrates a half-sectional view of the deployment device represented in FIG. 1 in a second ejection phase of the nanosatellite after the unlocking of the device.

FIG. 6 illustrates a top view of the deployment device of FIG. 1 representing an offset of the center of gravity of the nanosatellite relative to the center of thrust of the deployment device.

FIG. 7A illustrates a main structure of the deployment device represented in FIG. 1 equipped with a locking/unlocking structure in a locking position.

FIG. 7B illustrates a main structure of the deployment device represented in FIG. 1 equipped with a locking/unlocking structure in an open position.

FIG. 7C illustrates a main structure of the deployment device represented in FIG. 1 equipped with a locking/unlocking structure in an unlocking position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

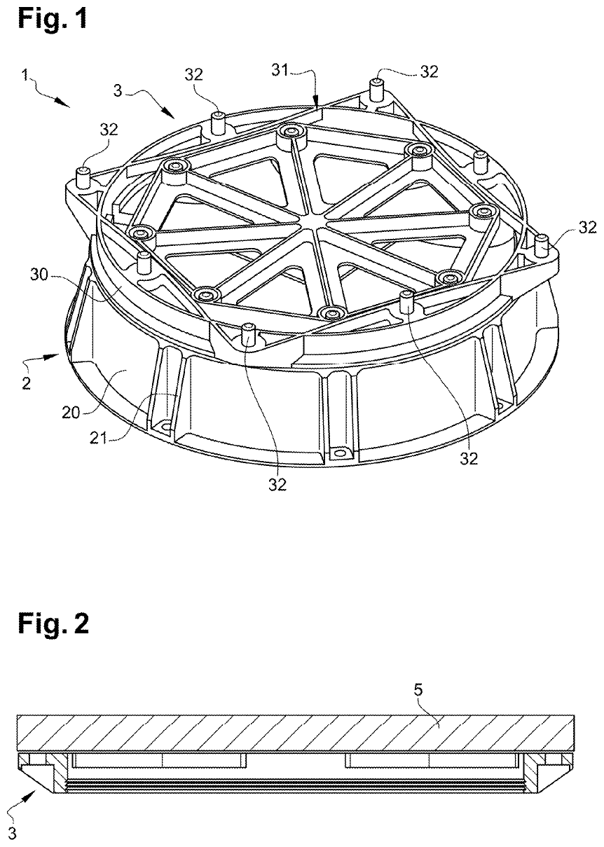

In FIG. 1, there is represented a deployment device 1 in the assembled state. The deployment device 1 comprises a main structure 2 provided to be mounted on a launching vehicle of the nanosatellite 5 (represented in FIG. 2), a support frame 3 provided to carry the nanosatellite 5 and to be ejected from the main structure 2 with the nanosatellite 5 and a structure 4 for locking/unlocking the support frame 3 with respect to the main structure 2.

The main structure 2 has a circular shape 20 reinforced on its outline by stiffeners 21, preferably integral therewith.

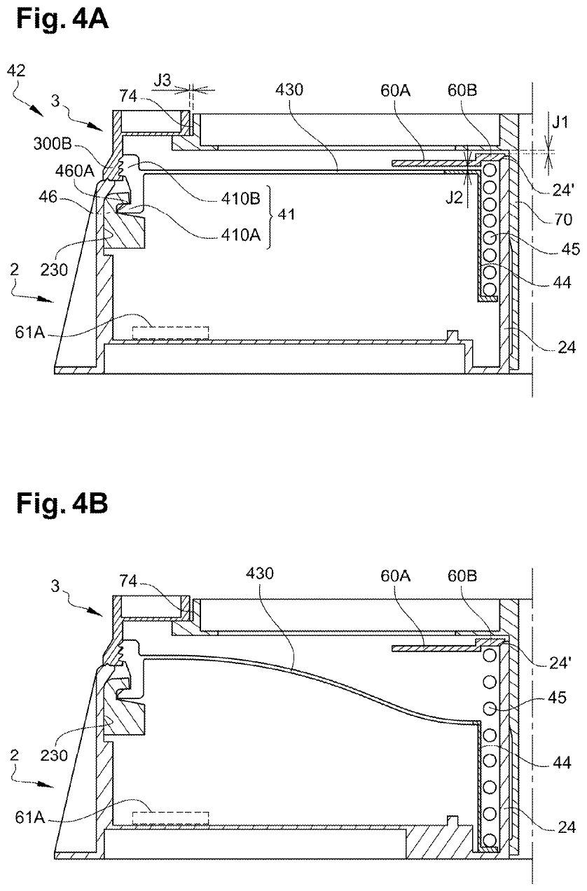

The support frame 3 has a circular shape 30 (FIGS. 4A and 4B) at its base to comply in shape matching with the main structure 2, the circular shape 30 is extended by a rectangular shape 31 to comply with the nanosatellite 5, as represented in FIG. 2, according to the Cubesat standard. Of course, the support frame 3 is not limited to this type of nanosatellite 5 and the rectangular shape 31 could be adapted to other shapes of nanosatellites 5.

In order to provide the fastening of the nanosatellite 5 on the support frame 3, the support frame 3 comprises a plurality of fastening elements 32. This plurality of fastening elements 32 makes it possible to immobilize the nanosatellite 5 on the support frame 3.

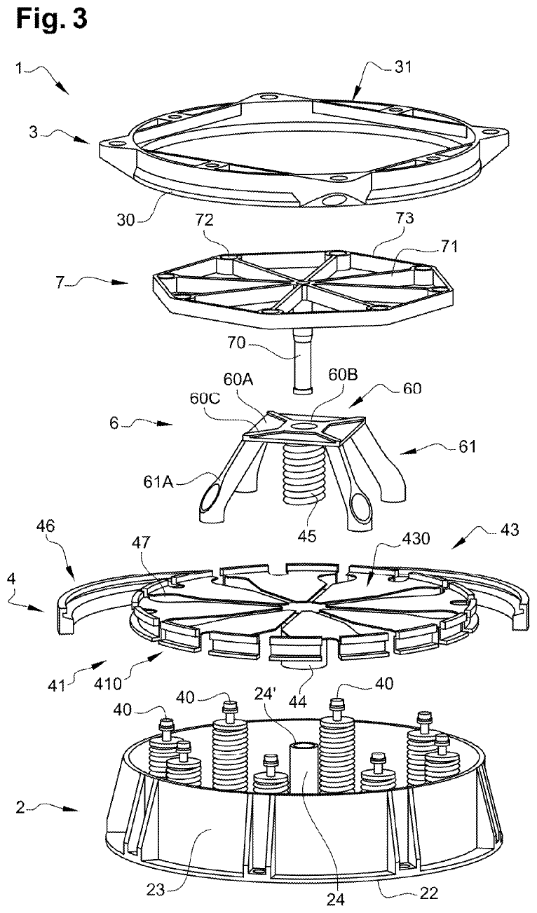

The locking/unlocking structure 4 is represented partially covered by the support frame 3 and will be detailed with reference to FIG. 3.

In FIG. 3, there is represented an exploded view of the deployment device 1 of FIG. 1.

The main structure 2 comprises a lower wall 22 and a peripheral wall 23 forming the outline of the main structure 2. A central shaft 24 extends in the center of the main structure 2 from the lower wall 22 to be terminated with free end 24′.

Furthermore, the main structure 2 carries a plurality of thrust elements 40 associated with the locking/unlocking structure 4 and regularly distributed around the central shaft 24.

As represented, the locking/unlocking structure 4 comprises, on the one hand, a first clamping element 41 complementary to a second clamping element 42 of the support frame 3, and, on the other hand, an elastically deformable actuating element 43.

The elastically deformable actuating element 43 allows the switching between: a locking position, to constrain the first clamping element 41 against the second clamping element 42 in order to retain the support frame 3 to the main structure 2, and

an unlocking position, to release the first clamping element 41 from the second clamping element 42 in order to release the support frame 3 from the main structure 2 causing it to be ejected.

The first clamping element 41 and the second clamping element 42 are respectively formed by a circular clamping ring 41, 42 complementary to each other.

More particularly, the circular clamping ring 41 forming the first clamping element 41 comprises a plurality of clamping jaws 410 and the actuating element 43 is formed by a plurality of elastically deformable blades 430.

As represented, the locking/unlocking structure 4 further comprises a peripheral shaft 44 guided by the central shaft 24 of the main structure 2 and receiving an unlocking elastic compression element 45 ensuring the switching from the locking position to the unlocking position.

The elastically deformable blades 430 extend from the peripheral shaft 44 to the clamping jaws 410 of the first clamping element 41.

The jaws 410 and the blades 430 are regularly distributed around the peripheral shaft 44.

The peripheral shaft 44, the elastically deformable blades 430 and the jaws 410 are advantageously integrally formed, by machining for example.

In the illustrated example, the first clamping element 41 and the second clamping element 42 form a radial clamping of the locking/unlocking structure 4 with respect to the support frame 3.

As illustrated, the locking/unlocking structure 4 comprises a retaining element 46 from the locking/unlocking structure 4 to the main structure 2.

The retaining element 46 is formed herein by a retaining ring 46 provided to engage with the first clamping element 41. The retaining element 46 thus allows the locking/unlocking structure 4 to be axially pre-constrained on the main structure 2.

In addition to the main structure 2, the support frame 3, the locking/unlocking structure 4, the deployment device 1 comprises a force take-up structure 6 provided to hold the free end 24′ of the central shaft 24, and it comprises a thrust plate 7.

As represented, the force take-up structure 6 is formed of a central part 60 surrounding the free end 24′ of the central shaft 24 and a peripheral part 61 extending from the central part 60 to bear laterally on the main structure 2.

The thrust plate 7 includes a guide tail 70 intended to be received in a central shaft 24 of the main structure 2. A plurality of lateral blades 71 extend radially from the peripheral shaft 44 to be joined by a peripheral edge 73. The peripheral edge 73 thus makes it possible to stiffen the plurality of lateral blades 71.

The thrust plate 7 is advantageously integrally formed, by molding for example.

The plurality of lateral blades 71 stiffened by the peripheral edge 73 allows supporting the support frame 3 on the thrust plate 7.

As represented, each lateral blade 71 of the thrust plate 7 comprises an opening 72.

Each opening 72 of the thrust plate 7 faces a passage 47 formed between two blades 430 of the actuating element 43 of the locking/unlocking structure 4. The opening 72 and the passage 47 are designed to be crossed by a thrust element 40 carried by the main structure 2.

The peripheral edge 73 has an octagonal shape provided to conform to a shape complementary to an inner outline of the support frame 3.

Reference is now made to FIG. 4A representing a half-sectional view of the deployment device 1 represented in a locking position.

As represented, the guide tail 70 of the thrust plate 7 is housed in the central shaft 24 and the thrust plate 7 is in flat abutment against the support frame 3 of the nanosatellite 5 so as to allow the ejection of the support frame 3 and the separation of the support frame 3 from the thrust plate 7 after ejection. The support frame 3 is hollowed out to receive the thrust plate 7.

In order to provide the axial holding of the support frame 3 relative to the thrust plate 7, a peripheral abutment 74 of the thrust plate 7 is provided.

A radial play J3 is provided between the support frame 3 and the thrust plate 7 in order to limit the radial constraints that may be applied to the support frame 3 during ejection.

The support frame 3 bears on the main structure 2 to provide a retaining of the support frame 3. The bearing of the support frame 3 on the main structure 2 is achieved by a correspondence of the slot/groove type.

It will be noted that the retaining element 46 of the locking/unlocking structure 4 is movably mounted with respect to the main structure 2.

Such an assembly allows the absorption of a part of the forces transmitted to the main structure 2.

In this case, the retaining element 46 is mounted in a clearance 230 of the peripheral wall 23 of the main structure 2. The clearance 230 allows an axial stroke of the retaining element 46.

The represented jaw 410 is engaged with both the retaining element 46 and the support frame 3.

More particularly, a hook 410A of the jaw 410 is radially in correspondence of a peripheral notch 460A of the retaining ring 46 forming the retaining element 46 and a toothed profile 410B of the jaw 410 corresponds radially to a toothed profile 300B of an inner outline of the support frame 3.

In the locking position, a first position of the peripheral shaft 44 comes to compress the unlocking elastic compression element 45. The unlocking elastic compression element 45 is caught between the peripheral shaft 44 and the central shaft 24. The first position of the peripheral shaft 44 forces an active position of the blade 430 in which the toothed profile 410B of the jaw 410 engages with the toothed profile 300B of the support frame 3, and in which the hook 410A of the jaw 410 engages with the peripheral notch 460A of the retaining ring 46.

In this locking position, the peripheral shaft 44 is in the high position.

The blade 430 is mechanically constrained in a radial direction and is devoid of an axial component.

As represented in FIGS. 3 and 4A, the central part 60 of the force take-up structure 6 comprises a flat wall 60A from which extends axially a hollow circular projection 60B and radially ribs 60C from the circular projection 60B.

The hollow circular projection 60B is provided for maintaining the unlocking elastic compression element 45 in the peripheral shaft 44.

An axial play J1 is provided between the force take-up structure 6 and the thrust plate 7, this to inhibit a static indeterminacy between these two pieces. The hollow circular projection 60B also allows the radial retaining of the free end 24′ of the central shaft 24.

In the same way, an axial play J2 is provided between the force take-up structure 6 and the actuating element 43, this to inhibit static indeterminacy between these two pieces.

The peripheral part 61 of the force take-up structure 6 comprises lateral arms 61A extending from the central part 60 to bear laterally on the main structure 2.

As represented in FIGS. 3 and 4A, the lateral arms 61A bear axially against the lower wall 22 of the main structure 2. It will be noted that these lateral arms 61A are distant from the peripheral wall 23 such that the forces of force take-up structure 6 are only transmitted to the lower wall 22.

The peripheral part 61 allows taking-up of the forces absorbed by the central part 60. In this case, the forces received by the central shaft 24, the blade 430 and thrust plate 7 are partly transmitted to peripheral part 61 via the central part 60.

The peripheral part 61 then transmits the forces received from central part 60 to main structure 2.

Reference is now made to FIG. 4B representing a half-sectional view of the deployment device 1 represented in an unlocking position.

In the unlocking position, a second position of the peripheral shaft 44 makes it possible to release the unlocking elastic compression element 45 and restores a passive position of the blade 430 in which the toothed profile 410B of the jaw 410 disengages from the toothed profile 300B of the support frame 3, and in which the hook 410A of the jaw 410 disengages from the peripheral notch 460A of the retaining ring 46.

In this unlocking position, the peripheral shaft 44 is in a low position.

The blade 430 is brought back to its constrained mechanical state. In this

state, the blade 430 comprises a radial component and an axial component.

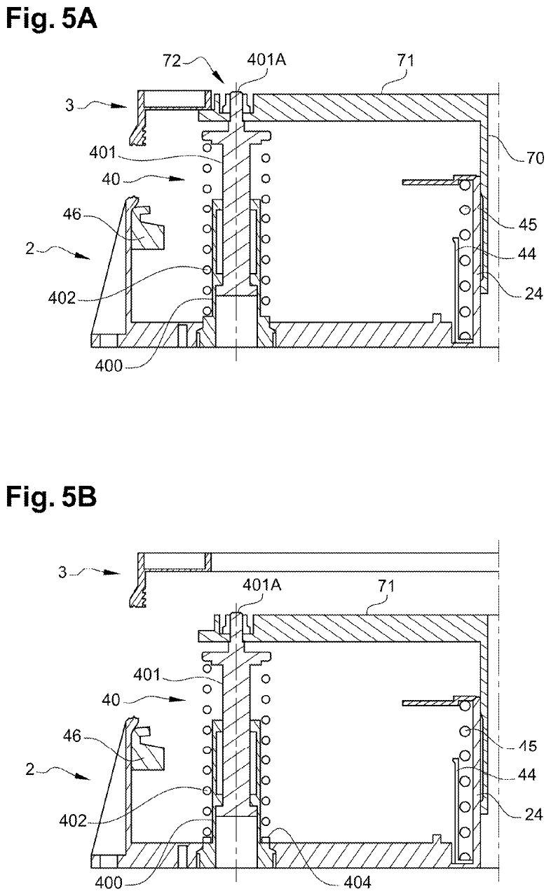

Reference is now made to FIG. 5A representing a half-sectional view of the deployment device 1 in a first ejection phase of the nanosatellite 5 after the unlocking of the device.

The plurality of thrust elements 40 represented in FIG. 3 provides a pre-loading of the thrust plate 7. This pre-loading has the effect of ensuring the thrust of the thrust plate 7 during the ejection.

In FIG. 5A, one of its thrust elements 40 has been represented. The thrust element 40 comprises a guide body 400 fixedly mounted on the main structure 2.

The guide body 400 receives a thrust rod 401 retaining a thrust spring 402 surrounding guide body 400. The thrust spring 402 is retained between guide body 400 and the thrust rod 401 for compression. This thrust rod 401 is provided to bear on thrust plate 7.

The thrust rod 401 has a rod head 401A fastened to the thrust plate 7. The rod head 401A passes through the opening 72 of the thrust plate 7 to be fastened thereto.

As represented, without being limited thereto, a means for fastening the head of the thrust rod 401 to the thrust plate 7 is herein a bolt.

Furthermore, the thrust rod 401 has the effect of limiting the radial force transmitted to the thrust plate 7.

When the pre-loading of the thrust plate 7 is carried out, the thrust rod 401 is lowered to compress the thrust spring 402.

When the thrust rod 401 is released upon unlocking, the thrust rod 401 slides in the guide body 400. The thrust rod 401 then slides to push the thrust plate 7.

Reference is now made to FIG. 5B representing a half-sectional view of the deployment device 1 in a second ejection phase of the nanosatellite 5 after the unlocking of the device.

The ejection of the support frame 3 carrying the nanosatellite 5 has been represented. The thrust rod 401 axially retains the thrust plate 7 thanks to its head secured to the thrust plate 7. The nanosatellite 5 is then ejected without the appendage represented by the guide tail 70.

As represented in FIGS. 5A and 5B, the thrust element 40 may comprise a setting wedge 404 provided on the guide body 400 to set the compression of the spring. The setting wedge may be moved axially along the guide body by means of screws pushing it axially.

The setting wedge 404 thus allows each thrust element 40 to be set independently to provide the most stable possible thrust of the support frame 3.

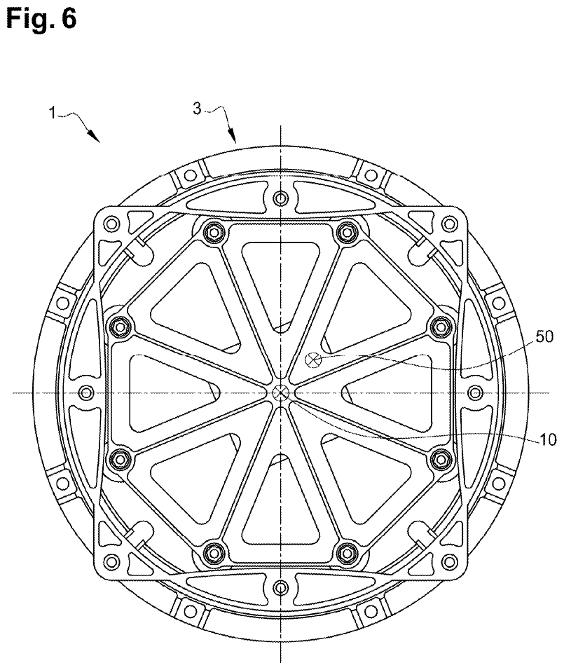

The deployment device 1 has been represented in FIG. 6. The center of gravity 50 of the nanosatellite 5, which in this case is illustrated offset from the center of thrust 10 of the thrust plate 7 has also been represented. The guide tail 70 of the thrust plate 7 and the plurality of thrust elements 40 that may be set by the setting wedge 404 makes it possible to compensate for this offset between the center of gravity 50 and the center of thrust 10 thanks to the compression of the thrust spring 402 independently of the thrust elements 40.

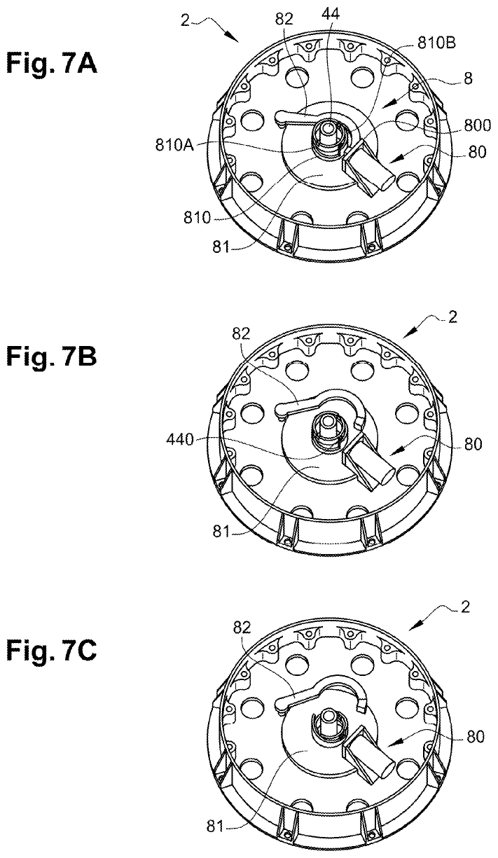

Reference is now made to FIGS. 7A to 7C where a mechanism 8 for retaining the actuating element 43 has been represented.

The retention mechanism 8 is provided to block the actuating element 43 in its locking position and to unblock the actuating element 43 in order to bring it into its unlocking position.

More particularly, the retention mechanism 8 makes it possible to block the peripheral shaft 44 in its first position and to unblock the peripheral shaft 44 in its second position.

The retention mechanism 8 comprises a blocking/unblocking element 80 which may be engaged radially to block the actuating element 43 in its locking position and may be disengaged radially to unblock the actuating element 43 and to bring it in its unlocking position.

The blocking/unblocking element 80 is herein formed by a magnetic control member consisting of a cylinder and a piston. Such a control device is also known by “Pin Puller”.

According to other variants, the control member may be constituted by an actuator, actuated for example by a pyrotechnic charge, an electromagnetic force or any other technology making it possible to fulfill the unlocking function.

The retention mechanism 8 comprises a cam 81 comprising a circular ramp 810 cooperating with a radial projection 440 of the peripheral shaft 44 able to bring the peripheral shaft 44 from its first position to its second position and vice versa.

As represented, the circular ramp 810 successively comprises an increasing linear portion 810A between a first position and a second position to allow an increasing linear guiding of the radial projection 440 from the low position to the high position of the peripheral shaft 44, then a flat linear portion 810B between the second position and a third position to allow the holding of the radial projection 440 in the upper position of the peripheral shaft 44, then the circular ramp 810 is interrupted between the third position and the first position to allow the switching of the radial projection 440 directly from the high position to the low position 15 of the peripheral shaft 44.

An elastic element (not represented) formed by a spiral spring is provided to bring the cam 81 back from a retaining position, where the peripheral shaft 44 is in its first position, to a rest position, where the peripheral shaft 44 is in its second position.

Furthermore, the retention mechanism 8 comprises a hooking element 82 which may be disposed between the blocking/unblocking element 80 and the cam 81 to maintain the cam 81 in its retained position.

The hooking element 82 surrounds at least partially the circular ramp 810 and is compressed against the latter by the blocking/unblocking element 80.

For this, the blocking/unblocking element 80 comprises a thrust plate 800 compressing the hooking element 82 against the circular ramp 810.

When the blocking/unblocking element 80 disengages radially, the hooking element 82 is elastically biased to be disengaged from the circular ramp 810, thus releasing the cam 81 to return it to its resting position.

The cam 81 is then elastically rotatably biased thus causing the rotation of the circular ramp 810.

The rotation of the circular ramp 810 then guides the radial projection 440 of the peripheral shaft 44 along it.

The radial projection 440 is then driven while causing the switching of the peripheral shaft 44 directly from its first position to its second position.

This second position of the peripheral shaft 44 brings the actuating element 43, herein the blade 430, into its passive position where the first clamping element 41 disengages from the second clamping element 42 to release the support frame 3.

The ejection of the support frame 3 of the nanosatellite 5 is then caused by the plurality of thrust elements 40.

Of course, the present disclosure is not limited to the examples that have just been described and many arrangements could be made to these examples yet without departing from the scope of the present disclosure. In particular, the different features, shapes, variants and forms of the present disclosure could be associated with one other according to various combinations to the extent that these are not incompatible or do not exclude each other. In particular, all of the previously described variants and forms could be combined together.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A deployment device of a nanosatellite comprising:
a main structure provided to be mounted on a launching vehicle of the nanosatellite,
a support frame provided to carry the nanosatellite and to be ejected from the main structure with the nanosatellite,
a locking/unlocking structure adapted to lock/unlock the support frame with respect to the main structure, wherein:
the locking/unlocking structure is movably mounted on the main structure,
the locking/unlocking structure comprises:
a first clamping element complementary to a second clamping element of the support frame, and
an elastically deformable actuating element adapted to:
in a locking position, constrain the first clamping element to the second clamping element to retain the support frame to the main structure, and
in an unlocking position, release the first clamping element from the second clamping element to release the support frame from the main structure causing it to be ejected.

2. The deployment device according to claim 1, wherein the first clamping element and the second clamping element radially and/or axially clamp the locking/unlocking structure with respect to the support frame.

3. The deployment device according to claim 1, wherein the first clamping element and the second clamping element have a toothed profile, wherein the toothed profiles are asymmetrical.

4. The deployment device according to claim 1, wherein the first clamping element and the second clamping element are respectively formed by a circular clamping ring complementary to one other.

5. The deployment device according to claim 4, wherein the circular clamping ring forming the first clamping element comprises a plurality of clamping jaws.

6. The deployment device according to claim 1, wherein the elastically deformable actuating element is formed by a plurality of elastically deformable blades.

7. The deployment device according to claim 1, wherein the locking/unlocking structure comprises a retaining element adapted to retain the locking/unlocking structure to the main structure.

8. The deployment device according to claim 7, wherein the retaining element is formed by a retaining ring complementary to the first clamping element.

9. The deployment device according to claim 1, wherein the elastically deformable actuating element comprises a peripheral shaft guided by a central shaft of the main structure, the peripheral shaft receiving an unlocking elastic compression element to switch from the locking position to the unlocking position.

10. The deployment device according to claim 9, wherein:
in the locking position, a first position of the peripheral shaft compresses the unlocking elastic compression element and forces an active position of the elastically deformable actuating element in which the first clamping element engages with the second clamping element and
in the unlocking position, a second position of the peripheral shaft releases the unlocking elastic compression element and restores a passive position of the elastically deformable actuating element in which the first clamping element disengages from the second clamping element.

11. The deployment device according to claim 1 further comprises:
a thrust plate including a guide tail receivable in a central shaft of the main structure,
wherein the support frame of the nanosatellite is in flat abutment on the thrust plate to eject the support frame and separate the support frame from the thrust plate after ejection.

12. The deployment device according to claim 11, wherein the locking/unlocking structure comprises a plurality of thrust elements to provide a pre-loading of the thrust plate.

13. The deployment device according to claim 12, wherein a thrust element from among the plurality of thrust elements comprises a guide body receiving a thrust rod retaining a thrust spring surrounding the guide body and retained between the guide body and the thrust rod, the thrust rod being provided to bear on the thrust plate.

14. The deployment device according to claim 13, wherein the thrust rod is secured to the thrust plate.

15. The deployment device according to claim 1 further comprises a force take-up structure to hold the free end of a central shaft of the main structure, the force take-up structure being formed of a central part surrounding the free end of the central shaft extending from the central part to bear laterally on the main structure.

16. The deployment device according to claim 1 further comprises a retention mechanism adapted to block the actuating element in its locking position and to unblock the elastically deformable actuating element to bring it into its unlocking position.
